(19) United States
(12) Patent Application Publication
(10) Pub. No.: US 2026/0190024 A1
(43) Pub. Date: Jul. 2, 2026

(54) COORDINATED RESTRICTED TARGET WAKE TIME SCHEDULE WITH JITTER

(71) Applicant: Cisco Technology, Inc., San Jose, CA (US)

(72) Inventors: Brian D. HART, Sunnyvale, CA (US); Binita GUPTA, San Diego, CA (US); Malcolm M. SMITH, Richardson, TX (US)

(21) Appl. No.: 19/281,654

(22) Filed: Jul. 26, 2025

Related U.S. Application Data
(60) Provisional application No. 63/740,269, filed on Dec. 30, 2024.

(51) Int. Cl. H04W 52/02; H04W 72/0446

(52) U.S. Cl. CPC H04W 52/0206; H04W 72/0446

(57) ABSTRACT

Techniques and apparatus for scheduling coordinated restricted target wake times (Co-RTWTs) with jitter are described. An example technique includes determining a schedule of service periods allocated to at least one of (i) one or more access point (AP) devices or (ii) one or more aggregated flows associated with the one or more AP devices. A first service period allocated to a first AP device for exchanging first traffic is determined based on the schedule of service periods. Upon determining, in the first service period, that a second AP device has second traffic that satisfies a predetermined condition, a portion of the first service period is allocated to the second AP device for communicating the second traffic.

### CROSS-REFERENCE TO RELATED APPLICATIONS

This application claims benefit of co-pending United States provisional patent application Serial No. 63/740,269 filed December 30, 2024. The aforementioned related patent application is herein incorporated by reference in its entirety.

### TECHNICAL FIELD

Embodiments presented in this disclosure generally relate to wireless communications. More specifically, embodiments disclosed herein provide techniques for scheduling coordinated restricted target wake times (Co-RTWTs) with jitter for wireless communications.

### BACKGROUND

Certain wireless communication standards, such as the Institute of Electrical and Electronics Engineers (IEEE) 802.11 technical standard (also known as Wi-Fi), support various features to enable low throughput and/or low-power communication and to reduce network contention in certain scenarios (e.g., dense Wi-Fi deployments). Among these features include target wake time (TWT), restricted TWT (RTWT), and coordinated RTWT (Co-RTWT). TWT allows devices to negotiate specific time slots (e.g., TWT service periods) with an access point (AP) to transmit and receive data, enabling the devices to sleep during other times and conserve power. TWT can help reduce contention in the network, lower power consumption, and improve overall network efficiency.

RTWT is a feature introduced in IEEE 802.11be (also known as Wi-Fi 7) that enhances the TWT mechanism. For example, while TWT aims to improve power efficiency by scheduling device wake times, RTWT reserves specific time slots for certain devices, ensuring exclusive channel access within the Basic Service Set (BSS) for those devices within the negotiated wake times. The reserved periods for data transmission created via RTWT can further minimize contention among devices.

Co-RTWT is a feature introduced in IEEE 802.11be that extends RTWT to multiple APs by coordinating the APs’ RTWT schedules. For example, Co-RTWT enables APs to align their RTWT schedules for improved network performance. With Co-RTWT, multiple APs on a channel can coordinate to avoid each other’s reserved time slots (e.g., RTWT service periods), improving channel utilization.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system, according to certain embodiments.

FIG. 2 illustrates an example workflow for randomizing mapping of service periods to one or more AP subsets, according to certain embodiments.

FIG. 3 illustrates another example workflow for randomizing mapping of service periods to one or more AP subsets, according to certain embodiments.

FIG. 4 illustrates an example residue report frame, according to certain embodiments.

FIG. 5 is a flowchart of a method for wireless communications, according to certain embodiments.

FIG. 6 illustrates an example computing device, according to certain embodiments.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### OVERVIEW

One embodiment described herein is a computer-implemented method performed by a computing device. The computer-implemented method includes determining a schedule of service periods allocated to at least one of (i) one or more access point (AP) devices or (ii) one or more aggregated flows associated with the one or more AP devices. The computer-implemented method also includes determining, based on the schedule of service periods, a first service period allocated to a first AP device for exchanging first traffic. The computer-implemented method further includes upon determining, in the first service period, that a second AP device has second traffic that satisfies a predetermined condition, allocating a portion of the first service period to the second AP device for communicating the second traffic.

Another embodiment described herein is a computing device. The computing device includes one or more memories collectively storing instructions and one or more processors communicatively coupled to the one or more memories. The one or more processors are individually or collectively configured to execute the instructions to cause the computing device to perform an operation. The operation includes determining a schedule of service periods allocated to at least one of (i) one or more access point (AP) devices or (ii) one or more aggregated flows associated with the one or more AP devices. The operation also includes determining, based on the schedule of service periods, a first service period allocated to a first AP device for exchanging first traffic. The operation further includes upon determining, in the first service period, that a second AP device has second traffic that satisfies a predetermined condition, allocating a portion of the first service period to the second AP device for communicating the second traffic.

Another embodiment described herein is a non-transitory computer-readable medium comprising computer-executable code, which when executed by one or more processors of a computing device perform an operation. The operation includes determining a schedule of service periods allocated to at least one of (i) one or more access point (AP) devices or (ii) one or more aggregated flows associated with the one or more AP devices. The operation also includes determining, based on the schedule of service periods, a first service period allocated to a first AP device for exchanging first traffic. The operation further includes, upon determining, in the first service period, that a second AP device has second traffic that satisfies a predetermined condition, allocating a portion of the first service period to the second AP device for communicating the second traffic.

### EXAMPLE EMBODIMENTS

Certain wireless systems (e.g., IEEE 802.11be among others) may support a variety of features, such as TWT, RTWT, and Co-RTWT among others, to enable low power communication between devices and/or improve medium contention between devices. However, while such features have allowed for improved network efficiency, these features can lead to in device coexistence (IDC) challenges for certain devices that have multiple wireless radios operating according to one or more radio access technologies (RATs) (e.g., cellular, 802.11 (also known as Wi-Fi), Bluetooth, ultra wideband (UWB), etc.). Additionally, a RAT may be used for multiple different services (via single instance of virtualized hardware or multiple distinct hardware instances, or some mix thereof), such as for infrastructure connectivity and for peer-to-peer (P2P) communications, whereby each service consumes (locks up) resources and/or creates interference. Such IDC challenges, in turn, can significantly impact the communication performance of devices in terms of increased latency, decreased throughput, and lower transmission range, as illustrative examples.

For instance, since Co-RTWT builds on RTWT, which builds on TWT, the TWT/RTWT/Co-RTWT schedule may be fully periodic, such as 3 milliseconds (ms) for every 20 ms, as an illustrative example. Because of this periodicity, the TWT schedule for a radio may conflict with the operation of another radio (or the same radio virtualized to support two or more different services) at a given instance in time, causing IDC challenges with the other (or same) radio. Because of this conflict, retries may not occur immediately and may be delayed until subsequent TWT service periods, where the device may be impacted by further IDC challenges due to, e.g., periodic Wi-Fi in combination with cellular or Bluetooth. Consequently, certain vendors of devices that include multiple radios operating according to different RATs or virtualized service through a single radio may not want to be subjected to the periodicity constraint, such as is described above, associated with Co-RTWT.

To address this, certain embodiments described herein provide systems and techniques for extending the TWT/RTWT and/or Co-RTWT schedule (collectively referred to herein as a Co-RTWT schedule) from being periodic to being deterministic and with more degrees of freedom than a periodic schedule. In certain aspects, providing a deterministic Co-RTWT schedule may involve randomizing the mapping of service periods to AP device subsets (e.g., AP device coordination groups where a coordination group of an AP device might be itself plus each other AP device with which the AP device has a multi-AP device coordination agreement, or might be itself plus each other AP device with which the AP device has multi-AP device coordination Co-RTWT profile agreements). By providing a deterministic Co-RTWT schedule, certain embodiments can increase the time-jitter of the service periods without introducing unnecessarily long gaps (e.g., gaps having a duration greater than a threshold amount of time). The deterministic Co-RTWT schedule may be used to simultaneously support clients with time-sensitive networking (TSN) traffic and other clients subject to IDC.

Although the terms “first,” “second,” “third,” etc., may be used herein to describe various elements, components, regions, layers and/or sections, these elements, components, regions, layers and/or sections should not be limited by these terms. These terms may be only used to distinguish one element, component, region, layer or section from another element, component, region, layer, or section. Terms such as “first,” “second,” and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

As used herein, a hyphenated form of a reference numeral refers to a specific instance of an element and the un-hyphenated form of the reference numeral refers to the collective element. Thus, for example, device “12-1” refers to an instance of a device class, which may be referred to collectively as devices “12” and any one of which may be referred to generically as a device “12”. As used herein, the terms “carrier,” “subcarrier,” “frequency channel,” “channel unit,” “channel,” and “tone” may be used interchangeably to refer to a frequency unit (or unit of frequency).

Note, the techniques described herein for randomizing the mapping of service periods to AP subsets may be incorporated into (such as implemented within or performed by) a variety of wired or wireless apparatuses (such as nodes). In some implementations, a node includes a wireless node. Such wireless nodes may provide, for example, connectivity to or from a network (such as a wide area network (WAN) such as the Internet or a cellular network) via a wired or wireless communication link. In some implementations, a wireless node may include an AP device, a controller, or a client device.

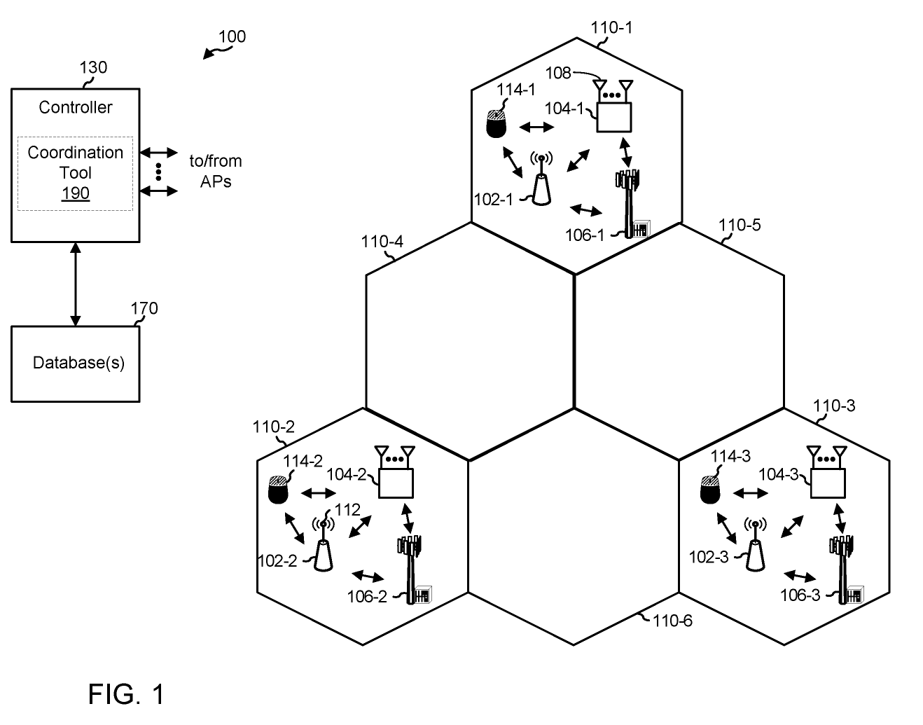

FIG. 1 illustrates an example system 100 in which one or more techniques described herein can be implemented, according to certain embodiments. The system 100 may implement a wireless network according to one or more of the 802.11 standards and/or its amendments. Here, the system 100 includes, without limitation, one or more client devices 104 communicating with any of various computing devices, such as AP devices 102, base stations 106, and/or wireless devices 114, as illustrative example. The client devices 104, AP devices 102, base stations 106, and/or wireless devices 114 may communicate via any of various RATs, including cellular, Wi-Fi, Bluetooth, UWB, among others. As noted, in certain cases, a RAT may be used for multiple different services (via single instance of virtualized hardware or multiple distinct hardware instances, or some mix thereof), such as for infrastructure connectivity and for P2P communications. Note while a certain number of client devices 104, AP devices 102, base stations 106, and wireless devices 114 are depicted, the system 100 may include any number of client devices 104, AP devices 102, base stations 106, and/or wireless devices 114.

An AP device 102 is generally a fixed device that communicates with other computing devices (e.g., client devices) and may be referred to as a Wi-Fi router, wireless device, or some other terminology. The base stations 106 are representative of cellular base stations, which may generally include a NodeB (NB), enhanced NodeB (eNB), next generation eNB (ng-eNB), next generation NodeB (gNB or gNodeB), base transceiver station, radio base station, radio transceiver, transceiver function, transmission reception point, and/or others. The base station 106 may provide communications coverage for a respective geographic coverage area, which may sometimes be referred to as a cell. For example, a base station 106 may provide communications coverage for a macro cell (covering relatively large geographic area), a pico cell (covering relatively smaller geographic area), a femto cell (covering a relatively smaller geographic area), and/or other types of cells. In some cases, the cell(s) may overlap (e.g., a small cell may have a coverage area that overlaps the coverage area of a macro cell). The wireless devices 114 may include any suitable wireless devices, such as internet of things (IoT) devices or other similar devices. Here, for example, the wireless devices 114-1, 114-2, and 114-3 may include wireless mice (e.g., Bluetooth mice).

A client device 104 may be fixed or mobile and is generally representative of a variety of wireless devices, such as a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, large or small kitchen appliance, healthcare device, implant, sensor/actuator, display, IoT device, always-on (AON) devices, edge processing devices, or other similar devices. A client device 104 may also be referred to more generally as a mobile device, a wireless device, a wireless communications device, a station (STA), a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

As used herein, an AP device along with the client devices and/or computing devices associated with the AP device (e.g., within the coverage area (or cell) of the AP device) may be referred to as a BSS. Here, BSS 110-1 includes AP device 102-1, client device 104-1 served by AP device 102-1, base station 106-1, and wireless device 114-1. BSS 110-2 includes AP device 102-2, client device 104-2 served by AP device 102-2, base station 106-2, and wireless device 114-2. BSS 110-3 includes AP device 102-3, client device 104-3 served by AP device 102-3, base station 106-3, and wireless device 114-3. In certain embodiments, the AP devices 102-1, 102-2, and 102-3 are co-channel AP devices (e.g., AP devices that operate on the same wireless channel(s)). For example, the BSSs 110-4, 110-5, and 110-5 may be located between the BSSs 110-1, 110-2, and 110-3 and may include AP devices (not shown) that operate on different channels than the AP devices 102-1, 102-2, and 102-3.

The AP devices 102 may communicate with one or more client devices 104 on the downlink and uplink. The downlink (e.g., forward link) is the communication link from the AP device 102 to the client device(s) 104, and the uplink (e.g., reverse link) is the communication link from the client device(s) 104 to the AP 102. In some cases, a client device may also communicate peer-to-peer with another client device. In certain embodiments, the AP devices 102-1, 102-2, and 102-3 are co-channel AP devices (e.g., AP devices that operate on the same wireless channel(s)).

As shown in FIG. 1, each client device 104 includes one or more radio resources 108 (e.g., physical radio hardware and/or virtualized radio hardware). In certain embodiments, the client device 104 can use a subset of the radio resources 108 to form links with an AP device 102, e.g., using one or more Wi-Fi RATs. Additionally or alternatively, in certain embodiments, the client device 104 can use another subset of the radio resources 108 to communicate with other computing devices, such as the base station 106, another client device 104, and/or wireless device 114, as illustrative examples. In these embodiments, the client device 104 may use one or more non-Wi-Fi RATs, other Wi-Fi radio(s), or a virtualized instance operating on the same Wi-Fi radio to communicate with the other computing devices. In an illustrative example, the client device 104 may communicate with one or more Bluetooth peripherals using a Bluetooth RAT, communicate with one or more UWB peripherals using a UWB RAT, communicate with one or more cellular base stations via a cellular RAT, and/or communicate with one or more other computing devices (e.g., wireless dock and other peripherals) using a Wi-Fi RAT.

Similarly, each AP device 102 includes one or more radio resources 112 (e.g., physical radio hardware and/or virtualized radio hardware). In certain embodiments, the AP device 102 can use a subset of the radio resources 112 to form links with one or more client devices 104 and/or one or more other AP devices 102, e.g., using one or more Wi-Fi RATs. Additionally or alternatively, the AP device 102 can use another subset of the radio resources 112 to communicate with other computing devices, such as the base station 106 and/or wireless device 114, as illustrative examples. In these embodiments, the AP device 102 may use one or more non-Wi-Fi RATs, other Wi-Fi radio(s), or a virtualized instance operating on the same Wi-Fi radio to communicate with the other computing devices.

In some instances, a client device 104 may form multiple links with a single AP device 102, e.g., using multiple Wi-Fi radios for MLO. For instance, a client device 104-1 can use a first set of radio resources 108 operating on a first band (e.g., 5 GHz band) to establish a first link with the AP device 102-1, a second set of radio resources 108 operating on a second band (e.g., 6 GHz band) to establish a second link with the AP device 102-1, a third set of radio resources 108 operating on a third band (e.g., 2.4 GHz band) to establish a third link with the AP device 102-1, and so on.

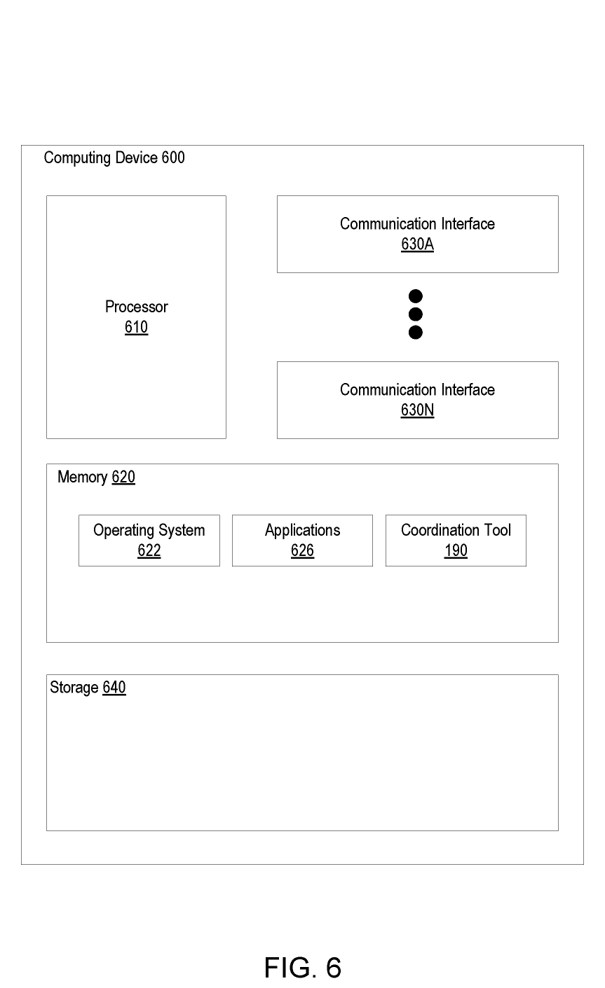

The operations of the controller 130 may be implemented by any device or system, and may be combined or distributed across any number of systems. For example, the controller 130 may be a WLAN controller for the AP devices 102 within the system 100. In some examples, the controller 130 is included within or integrated with an AP device 102 and coordinates the links formed by that AP device 102 (or otherwise provides control for that AP device). For example, each AP device 102 may include a controller that provides control for that AP device. In some examples, the functionality of the controller 130 is distributed across multiple AP devices 120 in communication amongst themselves. In some examples, the controller 130 is separate from the AP devices 102 and provides control for those AP devices. In FIG. 1, for example, the controller 130 may communicate with the AP devices 102 1-3 via a (wired or wireless) backhaul. The AP devices 102 1-3 may also communicate with one another, e.g., directly or indirectly via a wireless or wireline backhaul. Example hardware that may be included in a controller 130 or AP device 102 is discussed in greater detail with regard to FIG. 6.

The database(s) 170 are representative of storage systems that may include information associated with Co-RTWT schedules for the AP devices 102 in the network, AP device subsets, neighbor reports, AP device parameters (e.g., quality of service (QoS) basic service set (BSS) (QBSS) load, AP device power, AP device operating channel, etc.), radio resource management (RRM) information, or any combination thereof.

Note, that in certain embodiments, one or more of the client devices 104 may be referred to as client multi-link devices (MLDs) (e.g., a STA or client device acting as a MLD) and/or one or more of the AP devices 102 may be referred to as AP MLDs (e.g., an AP device that acts as a MLD). The client MLD and AP MLD are generally representative of any device capable of performing multi-link operations.

As noted, certain wireless networks may support TWT operation, RTWT operation, Co-RTWT operation, or a combination thereof, to reduce contention in the network. However, as noted in some cases, TWT/RTWT/Co-RTWT operation may lead to IDC challenges in devices that perform communications via multiple RATs. For example, certain client devices, such as smartphones, laptops, and IoT devices integrate multiple RATs within a single device. These technologies may include Bluetooth, Wi-Fi, UWB, cellular, etc. These communication modules often share common hardware resources without sufficient physical layer (PHY) isolation (e.g., through filtering) or isolated medium access control (MAC) designs. As a result, in certain cases, the Co-RTWT schedule for one radio may conflict with the operation of another radio within the same device, leading to IDC issues that impact the device’s communication performance in terms of reduced throughput, increased latency, and lower transmission range, as illustrative examples.

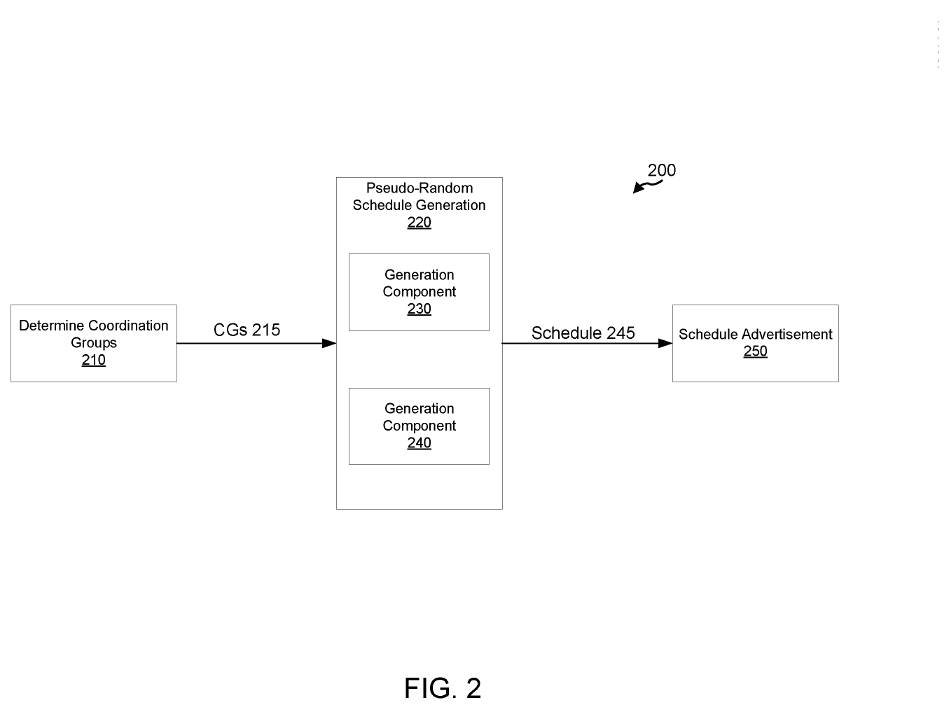

To address this, certain embodiments described herein provide techniques for deterministically pseudo-randomizing the mapping of service periods to AP device subsets. As shown, the controller 130 includes a coordination tool 190, which is configured to perform one or more techniques described herein for deterministically pseudo-randomizing the mapping of service periods to AP device subsets. The coordination tool 190 may include software, hardware, or a combination thereof. Note, the coordination tool 190 is described in greater detail herein with respect to FIGS. 2-3 and 5.

The pseudo-randomization of service periods to AP subsets described herein may allow the Co-RTWT schedule to be deterministic as opposed to periodic, reducing the likelihood of a device being impacted in an ongoing manner by IDC issues. As such, embodiments herein can improve the device’s communication performance in terms of decreased latency, increased throughput, and increased reliability, as illustrative examples.

FIG. 2 illustrates an example workflow 200 for deterministically pseudo-randomizing the mapping of service periods to AP device subsets, according to certain embodiments. The workflow 200 may be performed by a computing device, such as a controller (e.g., controller 130) or an AP device (e.g., a Co-RTWT initiating AP device, such as AP device 102), as illustrative examples. In certain embodiments, the workflow 200 may be implemented by a coordination tool (e.g., coordination tool 190).

At block 210, given an AP device deployment, the coordination tool determines a set of coordination groups (CGs) 215 for the AP device deployment. For example, the coordination tool may allocate a deployment of AP devices into C CGs, where each CG includes one or more respective BSSs. In certain embodiments, the coordination tool allocates co-channel AP devices (e.g., BSSs 110-1, 110-2, and 110-3) into C CGs, such that same-CG AP devices are physically separated (i.e., out of range) from one another. In some such embodiments, an AP device may not have any other co-channel AP devices (perhaps by virtue of decision making at an RRM subsystem), so C = 1. In some other such embodiments, the coordination tool always has C = 1and the same-CG AP devices are still in range of each other.

In certain wireless systems, service periods may be mapped to AP devices, based on the CGs 215. For example, over time, one CG may be given access to the channel for the traffic of the BSSs in that CG. Assuming C = 3 for CG m, CG n, and CG p, the allocation may be mnpmnpmnpmnp … for the three CGs m, n, and p. In certain wireless systems, service periods may be mapped to (semi-)periodic flows (or aggregation of like flows) carried by an AP device or set of nearby AP devices. Call this value C. For example, over time, one flow(-aggregation) may be given access to the channel for the traffic of that flow(-aggregation). Assuming three flow(-aggregation)s with m for the first flow(-aggregation), n for the second flow(-aggregation), and p for the third flow(-aggregation), the allocation may be mnpmnpmnpmnp … for the three flow(-aggregation)s m, n, and p.

At block 220, the coordination tool may transform the periodic allocation of the C GGs or flow(-aggregation)s into a pseudorandom sequence of the C CGs or flow(-aggregation)s. For example, at block 220, the coordination tool generates a pseudorandom source (e.g., pseudorandom sequence (PRBS) or cryptographic hash of an incrementing counter).

In certain embodiments, the coordination tool uses a generation component 230 to generate a pseudorandom schedule 245, based on the pseudorandom source. For example, the coordination tool (via the generation component 230) may (i) combine multiple output bits of the pseudorandom source into a N bit word (e.g., 8 or 16 bits) and (ii) take the modulo of the N-bit word with respect to C! (C factorial), e.g., in order to generate a pseudorandom sequence of integers 0 … C!-₁. The coordination tool may use such random integers as an index to a permutation for the next C slots, so that every C service periods, the ordering of the service periods changes in a pseudo-random manner.

Additionally, in some such embodiments, the coordination tool (via the generation component 230) may ensure that the maximum gap (e.g., number of service periods) between the start of two service periods for the same CG or set of flow(-aggregation)s is less than D = 2*C-1. Here, in these embodiments, instead of waiting up to C-1 service periods to get service again, the traffic within a CG or set of flow(-aggregation)s may wait a pseudorandom number of service periods up to some limit (e.g., D service periods). In certain cases, deterministically pseudo-randomizing the mapping of service periods can strongly decorrelate the service period allocation and IDC, increasing the likelihood of retries (if any) succeeding and thereby helping devices subject to IDC. Note that while D service periods may be larger than C-1 service periods, in certain embodiments, the duration of each service period may be shortened (e.g., halved), so that delay targets for critical traffic (e.g., TSN traffic) can be met despite the larger D.

In certain other embodiments, the coordination tool uses a generation component 240 to generate a pseudorandom schedule 245, based on the pseudorandom source. For example, the coordination tool (via the generation component 240) may (i) combine multiple output bits of the pseudorandom source into an N bit word (e.g., 8 or 16 bits), (ii) threshold the N bit word into C equal (or nearly equal) ranges (e.g., if C = 3, then the ranges over 8 bits may be 0-84 (85), 85-170 (86), 171-255 (85)), and (iii) map each range to a CG or flow(-aggregation). In certain embodiments, performing thresholding in this manner may lead to a pseudo-randomized sequence, such as mmnnppmnppnmppmmnn … . In some cases, the PBRS can have a long run of zeros or ones leading to a long service period starvation of m’s, p’s, or n’s. Accordingly, in certain embodiments, if the coordination tool determines that a CG or flow(-aggregation) has been starved for a period of time greater than or equal to D = 2*C consecutive service periods, then the coordination tool may forcibly assign the next service period to that CG. Note, however, that the coordination tool may also use other constructions that create predictable yet random-like allocations of service periods to CGs without creating long periods when a CG is not allocated a service period for a significant amount of time.

At block 250, the coordination tool may advertise the pseudorandom schedule 245 within the network. For example, the coordination tool may share the pseudorandom schedule to one or more AP devices, or the AP devices may share the pseudorandom sequence amongst themselves. This schedule may be described by (or otherwise include) a small number of parameters, such as the current value of the counter, C, and (if a method is not statically chosen) parameters that relate to how the counter value is mapped to an ordering.

In certain embodiments, when solving for clients affected by IDC, it may be sufficient for AP devices to signal the pseudorandom schedule 245 to IDC-affected clients, as opposed to every client, so the IDC-affected clients know when to wake up for service.

In certain other embodiments, the AP devices may distribute their SCS and QoS flow agreements (e.g., for TSN flows) to all neighboring co-channel AP devices. If an AP device is using its random service period, but knows that a QoS flow in an OBSS needs servicing, then the AP device can use Co-TDMA to briefly enable that OBSS AP device and client for delivering their QoS flow. Here, for clients affected by IDC, it may be sufficient to for AP devices to signal the pseudorandom schedule 245 to IDC-affected clients. In terms of scalability, if there are P neighboring co-channel AP devices (P = 0, 1, 2, 3, …), then up to P Co-TDMA refarmings may be used in a transmit opportunity (TXOP). In certain embodiments, the coordination tool may add pseudorandom timing to TWT and RTWT agreements for IDC-affected clients.

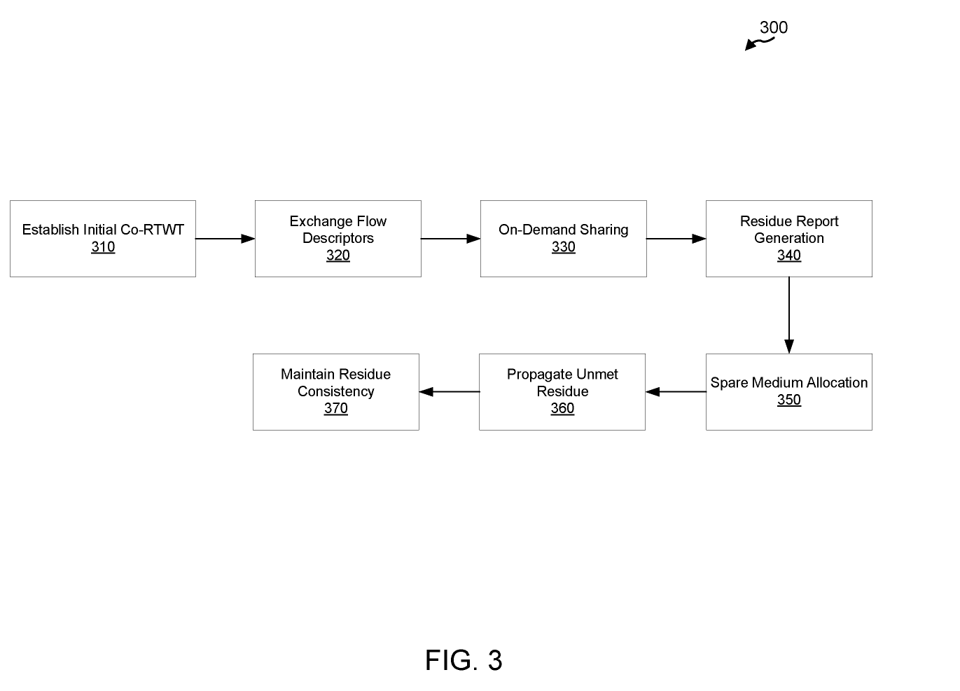

FIG. 3 illustrates an example workflow 300 for deterministically pseudo-randomizing mapping of service periods to AP device subsets, according to certain embodiments. As per above, in some cases, instead of a SP being allocated to an AP device, the SP might instead be allocated to an (aggregated-)flow. Accordingly, note that the term “AP device” may be used to refer to an “AP device” or “(aggregated-)flow.” The workflow 300 may be performed by a computing device or multiple computing devices. The computing device(s) may include a controller (e.g., controller 130) or an AP device (e.g., a Co-RTWT initiating AP, such as AP 102), as illustrative examples. In certain embodiments, the workflow 300 may be implemented by a coordination tool (e.g., coordination tool 190).

At block 310, the coordination tool establishes an initial Co-RTWT schedule for a set of AP devices. For example, the coordination tool may assign each AP device one service period every N service periods (e.g., mnpmnpmnpmnp … ).

At block 320, the coordination tool exchanges flow descriptors with one or more neighboring AP devices. For example, the coordination tool may distribute SCS/QoS flow agreements (e.g., for TSN flows) to neighboring co-channel AP devices. Each neighboring AP device may share, via unicast or multicast, its SCS/QoS flow agreements so that every AP device knows latency budgets for other BSSs.

At block 330, the coordination tool performs on-demand Co-TDMA sharing with one or more neighboring AP devices. For example, if an AP device is using its service period and determines that a QoS flow in an OBSS needs servicing, then the AP device can use Co-TDMA to briefly enable that OBSS AP device and client for delivering their QoS flow. That is, while occupying its own service period, an AP device can instantly loan portions of time (from its service period) to a neighbor AP device/client device pair that has to deliver critical traffic (e.g., one or more TSN frames). If a peer AP device has not shared this SCS / QoS flow agreement information, or if the information is stale (e.g., the peer AP device and its client might already have delivered their traffic on another MLO link), then the AP device might initiate a Co-TDMA exchange based on the higher likelihood that the peer AP device needs wireless resources at present, and the peer AP device can reports its current needs near the beginning of the Co-TDMA TXOP.

At block 340, the coordination tool may generate and transmit a residue report to the next AP device whose service period comes next. For example, if an AP device still has unserved traffic when its service period is about to expire, then the AP device may send a residue report (e.g., unicast frame) to the AP device whose service period comes next. The AP device may have unserved traffic due to unexpectedly more traffic, the need for retries, due to IDC constraints, etc.

In certain embodiments, the residue report may indicate the amount of time needed per AC/TID and/or per BSSID. For example, the residue report may indicate “still need XX ms more of medium time before MSDU expiry in ZZ ms” per AC/TID for all ACs/TIDs or just for some (e.g., with more urgent requirements, or that are for higher priority traffic. In another example, the residue report may include 1 bit signaling “need more time” or some other indication. In some cases, if there are IDC constraints at the AP device or the clients that the AP device is serving, then the sending AP device may report one delay value or request a random delay.

At block 350, the coordination tool, in the next service period, may allocate spare medium time (or more generally, spare medium resources of the current TXOP, such as a portion of the channel bandwidth for sharing via OFDMA or FDMA) to the owner(s) of the residue report. For example, the receiving AP device, during its service period, may allocate spare medium resources to the transmitting AP device(s) via Co-TDMA according to priority and available medium time.

At block 360, the coordination tool may propagate any unmet residue into a new residue report. For example, any unmet residue (including old residue and new residue) may be rolled into another residue report and forwarded along the service period chain. For instance, if the receiving AP device is not able to service everything of the old AP device(s) as well as itself, then the receiving AP device can report the old AP device(s)’ residual residue (after pruning entries whose ZZ has elapsed) in addition to the receiving AP device’s new residue to the subsequent AP device in its transmitted residue report. In this manner, the residue report may include an accumulation of medium time still needed for non-expired traffic.

At block 370, the coordination tool may maintain residue consistency. For example, AP devices may track over-the-air (OTA) exchanges to age or delete stale residue entries. That is, if there is a gap arising from over-the-air collisions when using CSMA/CA by any AP device, the residue report may become stale.

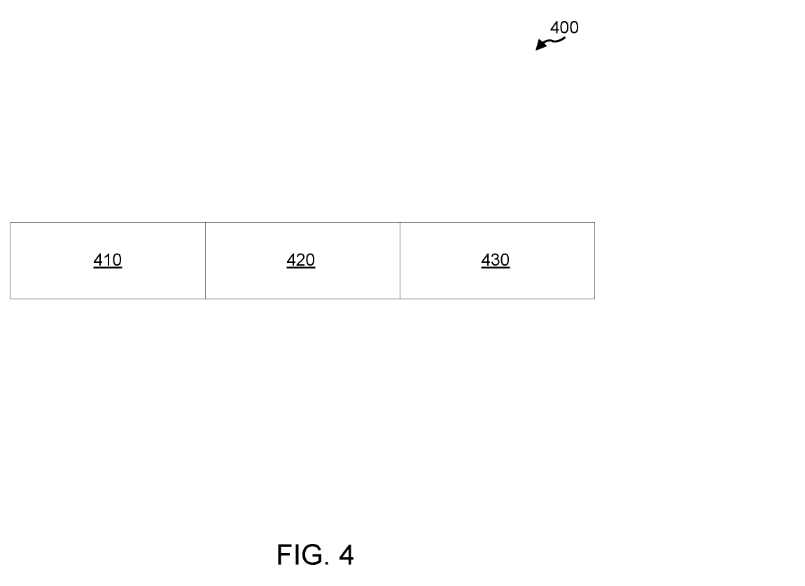

FIG. 4 illustrates an example residue report frame 400, according to certain embodiments. The residue report frame 400 may include a field 410, a field 420, a field 430, or a combination thereof. In certain embodiments, the residue report frame 400 may include information associated with a list of AP devices. For example, the residue report frame 400 may include a list of tuples, where each tuple is associated with a respective AP device or an AP device’s radio and may include fields 410, 420, and/or 430. Additionally, in certain embodiments, the residue report frame 400 may have varying levels of breadth and/or granularity for each of the fields 410, 420, and/or 430.

For example, at a lowest level of granularity (e.g., most coarse), the field 410 may include an indication of the medium time (XX ms) required to transfer an AP device’s residue per radio. At a relatively higher level of granularity, the field 410 may include an indication of the medium time (XX ms) required to transfer the AP device’s residue per BSS for all BSSs or for specific BSSs (e.g., high priority BSSs and/or BSSs with non-empty queues). At another relatively higher level of granularity, the field 410 may include an indication of the medium time (XX ms) required to transfer the AP device’s residue per AC/TID for all ACs/TIDs or for specific ACs/TIDs (e.g., a set of high priority ACs/TIDs and/or non-empty ACs/TIDs). At a highest level of granularity, the field 410 may include an indication of the medium time (X ms) required to transfer an AP device’s residue per BSS per AC/TID for all ACs/TIDs of each BSS or for specific ACs/TIDs (e.g., a set of high priority ACs/TIDs and/or non-empty ACs/TIDs) of each BSS. Note, the indication of the AP’s residue per BSS may be tagged with the BSSID of the BSS.

Similarly, at a lowest level of granularity (e.g., most coarse), the field 420 may indicate the expiry time after which the medium time is no longer needed (ZZ ms) per radio. At a relatively higher level of granularity, the field 420 may indicate the expiry time after which the medium time is no longer needed (ZZ ms) per BSS for all BSSs or for specific BSSs (e.g., high priority BSSs and/or BSSs with non-empty queues). At another relatively higher level of granularity, the field 420 may indicate the expiry time after which the medium time is no longer needed (ZZ ms) per AC/TID for all ACs/TIDs or for specific ACs/TIDs (e.g., a set of high priority ACs/TIDs and/or non-empty ACs/TIDs). At a highest level of granularity, the field 420 may indicate the expiry time after which the medium time is no longer needed (ZZ ms) per BSS per AC/TID for all ACs/TIDs of each BSS or for specific ACs/TIDs (e.g., a set of high priority ACs/TIDs and/or non-empty ACs/TIDs) of each BSS.

Similarly, the field 430 may indicate a delay before which medium time is not required (e.g., YY ms) since the recipient is busy due to IDC-related unavailability. In cases, where the field 430 is not present, YY may be assumed to be equal to 0. At a lowest level of granularity, the field 430 may indicate the delay (e.g., YY ms) per radio. At a relatively higher level of granularity, the field 430 may indicate the delay (e.g., YY ms) per BSS for all BSSs or for specific BSSs (e.g., high priority BSSs and/or BSSs with non-empty queues). At another relatively higher level of granularity, the field 430 may indicate the delay (e.g., YY ms) per AC/TID for all ACs/TIDs or for specific ACs/TIDs (e.g., a set of high priority ACs/TIDs and/or non-empty ACs/TIDs). At a highest level of granularity, the field 430 may indicate the delay (e.g., YY ms) per BSS per AC/TID for all ACs/TIDs of each BSS or for specific ACs/TIDs (e.g., a set of high priority ACs/TIDs and/or non-empty ACs/TIDs) of each BSS.

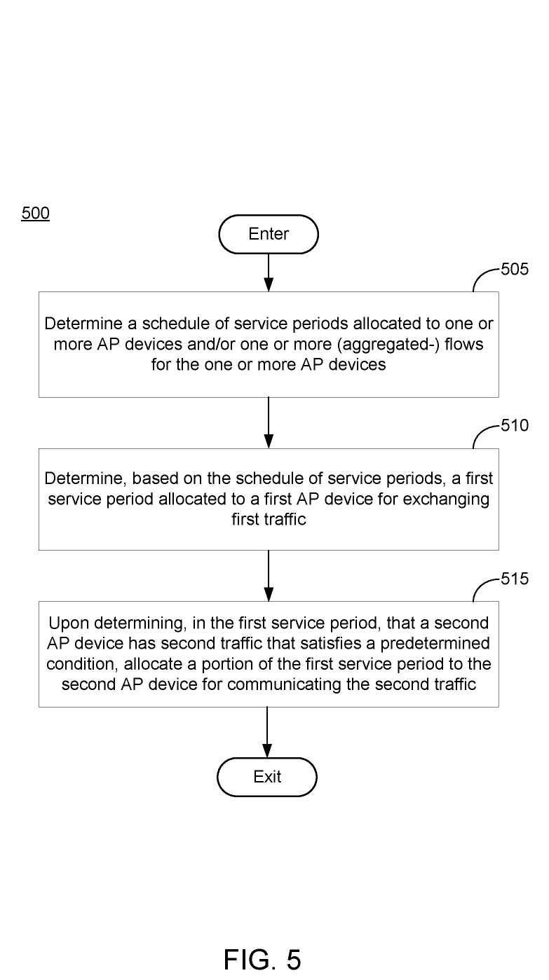

FIG. 5 is a flowchart of a method 500 for wireless communications, according to certain embodiments. The method 500 may be performed by a computing device, such as an AP device (e.g., AP device 102-1) or controller (e.g., controller 130).

Method 500 enters at block 505, where the computing device determines a schedule of service periods allocated to at least one of a set of (aggregated-)flows serviced by a group of AP devices or a single CG (including one or more AP devices assigned to the single CG).

At block 510, the computing device determines, based on the schedule of service periods, a first service period allocated to a first AP device for exchanging first traffic.

At block 515, upon determining, in the first service period, that a second AP device has second traffic that satisfies a predetermined condition, the computing device allocates a portion of the first service period (or a portion of a TXOP within the first service period) to the second AP device for communicating the second traffic.

In certain embodiments, the method 500 further includes upon determining, in the first service period, that a portion of the first traffic is not able to be served within the first service period: (i) generating a frame comprising an indication of an amount of time needed to serve the portion of the first traffic; and (ii) transmitting the frame to a third AP device. The third AP device may be the same as the second AP device.

In certain embodiments, a second service period in the schedule of service periods and adjacent to the first service period is allocated to the third AP device.

In certain embodiments, the frame further includes an indication of an amount of time remaining before an indication of the expiration of the portion of the first traffic. The indication might be the first-expiring MSDU or the head-of-line of the queue of MSDUs. In some such embodiments, the amount of time is indicated per access category of the portion of the first traffic, per traffic identifier of the portion of the first traffic, per BSS, or a combination thereof. In some such embodiments where the amount of time is reported for a given part of a partition, the amount of time may be reported for all parts of the partition, or all high priority parts, or all parts with non-zero requirements, or all high priority parts with non-zero requirements.

In certain embodiments, the frame further includes an indication, from a fourth AP device, of an amount of time needed to service a portion of fourth traffic in a second service period prior to the first service period.

In certain embodiments, the schedule of service periods includes a pseudorandom schedule of service periods.

In certain embodiments, the first AP device lacks consecutive allocation of service periods within the schedule of service periods.

In certain embodiments, a maximum duration between any two service periods allocated to the first AP device within the schedule is less than a threshold based on a total number of the set of coordination groups.

In certain embodiments, the predetermined condition includes a predefined type of traffic or a threshold priority.

FIG. 6 illustrates an example computing device 600, according to one embodiment. The computing device 600 can be configured to perform one or more techniques described herein. For example, the computing device 600 can perform workflow 200, workflow 300, method 500, and any other techniques (or combination of techniques) described herein. The computing device 600 may be representative of a controller (e.g., controller 130) or a network entity (e.g., an AP, such as AP 102). The computing device 600 includes, without limitation, a processor 610, a memory 620, one or more communication interfaces 630a-n. In one example, a communication interface 630 includes a radio.

The processor 610 may be any processing element capable of performing the functions described herein. The processor 610 represents a single processor, multiple processors, a processor with multiple cores, and combinations thereof. The communication interfaces 630 (e.g., radios) facilitate communications between the computing device 600 and other devices. The communications interfaces 630 may include wireless communications antennas and various wired communication ports.

The memory 620 may be either volatile or non-volatile memory and may include RAM, flash, cache, disk drives, and other computer readable memory storage devices. Although shown as a single entity, the memory 620 may be divided into different memory storage elements such as RAM and one or more hard disk drives. As shown, the memory 620 includes various instructions that are executable by the processor 610 to provide an operating system 622 to manage various functions of the computing device 600. The memory 620 also includes a coordination tool 190 and one or more application(s) 626.

The computing device 600 may include storage 640. In some cases, the storage 640 may be a disk drive or flash storage device. In some cases, the storage 640 may be a combination of fixed and/or removable storage devices, such as fixed disc drives, solid state drives, removable memory cards, optical storage, network attached storage (NAS), or a storage area-network (SAN).

### Example Clauses

Implementation examples are described in the following numbered clauses:

Clause 1: A computer-implemented method performed by a computing device, comprising: determining a schedule of service periods allocated to at least one of (i) one or more access point (AP) devices or (ii) one or more aggregated flows associated with the one or more AP devices; determining, based on the schedule of service periods, a first service period allocated to a first AP device for exchanging first traffic; and upon determining, in the first service period, that a second AP device has second traffic that satisfies a predetermined condition, allocating a portion of the first service period to the second AP device for communicating the second traffic.

Clause 2: The computer-implemented method of Clause 1, further comprising upon determining, in the first service period, that a portion of the first traffic is not able to be served within the first service period: generating a frame comprising an indication of an amount of time needed to serve the portion of the first traffic; and transmitting the frame to a third AP device.

Clause 3: The computer-implemented method of Clause 2, wherein a second service period in the schedule of service periods and adjacent to the first service period is allocated to the third AP device.

Clause 4: The computer-implemented method in accordance with any of Clauses 2-3, wherein the frame further comprises an indication of an amount of time remaining before an indication of an expiration of the portion of the first traffic.

Clause 5: The computer-implemented method of Clause 4, wherein the amount of time is indicated: (i) per radio, (ii) per basic service set (BSS) for a plurality of BSSs in a network or for a subset of the plurality of BSSs, (iii) per access category/traffic identifier (TID) of the portion of the first traffic for a plurality of ACs/TIDs associated with traffic in the network or for a subset of the plurality of ACs/TIDs, or (iv) per BSS per AC/TID for the plurality of ACs/TIDs of each of the plurality of BSSs or for the subset of the plurality of ACs/TIDs of each of the plurality of BSSs.

Clause 6: The computer-implemented method in accordance with any of Clauses 2-5, wherein the frame further comprises an indication, from a fourth AP device, of an amount of time needed to service a portion of fourth traffic in a second service period prior to the first service period.

Clause 7: The computer-implemented method in accordance with any of Clauses 1-6, wherein the schedule of service periods comprises a pseudorandom schedule of service periods.

Clause 8: The computer-implemented method in accordance with any of Clauses 1-7, wherein the first AP device lacks consecutive allocation of service periods within the schedule of service periods.

Clause 9: The computer-implemented method in accordance with any of Clauses 1-8, wherein a maximum duration between any two service periods allocated to the first AP device within the schedule is less than a threshold based on a total number of the one or more AP devices.

Clause 10: The computer-implemented method in accordance with any of Clauses 1-9, wherein the predetermined condition comprises a predefined type of traffic or a threshold priority.

Clause 11: A computing device comprising: one or more memories collectively storing instructions; and one or more processors communicatively coupled to the one or more memories, the one or more processors being individually or collectively configured to execute the instructions to cause the computing device to perform a method in accordance with any of Clauses 1-10.

Clause 12: A non-transitory computer-readable medium comprising computer-executable code, which when executed by one or more processors of a computing device perform a method in accordance with any of Clauses 1-10.

Clause 13: An apparatus comprising means for performing a method in accordance with any of Clauses 1-10.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A computer-implemented method performed by a computing device, comprising:
determining a schedule of service periods allocated to at least one of (i) one or more access point (AP) devices or (ii) one or more aggregated flows associated with the one or more AP devices;
determining, based on the schedule of service periods, a first service period allocated to a first AP device for exchanging first traffic; and
upon determining, in the first service period, that a second AP device has second traffic that satisfies a predetermined condition, allocating a portion of the first service period to the second AP device for communicating the second traffic.

2. The computer-implemented method of claim 1, further comprising upon determining, in the first service period, that a portion of the first traffic is not able to be served within the first service period:
generating a frame comprising an indication of an amount of time needed to serve the portion of the first traffic; and
transmitting the frame to a third AP device.

3. The computer-implemented method of claim 2, wherein a second service period in the schedule of service periods and adjacent to the first service period is allocated to the third AP device.

4. The computer-implemented method of claim 2, wherein the frame further comprises an indication of an amount of time remaining before an indication of an expiration of the portion of the first traffic.

5. The computer-implemented method of claim 4, wherein the amount of time is indicated: (i) per radio, (ii) per basic service set (BSS) for a plurality of BSSs in a network or for a subset of the plurality of BSSs, (iii) per access category/traffic identifier (TID) of the portion of the first traffic for a plurality of ACs/TIDs associated with traffic in the network or for a subset of the plurality of ACs/TIDs, or (iv) per BSS per AC/TID for the plurality of ACs/TIDs of each of the plurality of BSSs or for the subset of the plurality of ACs/TIDs of each of the plurality of BSSs.

6. The computer-implemented method of claim 2, wherein the frame further comprises an indication, from a fourth AP device, of an amount of time needed to service a portion of fourth traffic in a second service period prior to the first service period.

7. The computer-implemented method of claim 1, wherein the schedule of service periods comprises a pseudorandom schedule of service periods.

8. The computer-implemented method of claim 1, wherein the first AP device lacks consecutive allocation of service periods within the schedule of service periods.

9. The computer-implemented method of claim 1, wherein a maximum duration between any two service periods allocated to the first AP device within the schedule is less than a threshold based on a total number of the one or more AP devices.

10. The computer-implemented method of claim 1, wherein the predetermined condition comprises a predefined type of traffic or a threshold priority.

11. A computing device comprising:
one or more memories collectively storing instructions; and
one or more processors communicatively coupled to the one or more memories, the one or more processors being individually or collectively configured to execute the instructions to cause the computing device to perform an operation comprising:
determining a schedule of service periods allocated to at least one of (i) one or more access point (AP) devices or (ii) one or more aggregated flows associated with the one or more AP devices;
determining, based on the schedule of service periods, a first service period allocated to a first AP device for exchanging first traffic; and
upon determining, in the first service period, that a second AP device has second traffic that satisfies a predetermined condition, allocating a portion of the first service period to the second AP device for communicating the second traffic.

12. The computing device of claim 11, the operation further comprising upon determining, in the first service period, that a portion of the first traffic is not able to be served within the first service period:
generating a frame comprising an indication of an amount of time needed to serve the portion of the first traffic; and
transmitting the frame to a third AP device.

13. The computing device of claim 12, wherein a second service period in the schedule of service periods and adjacent to the first service period is allocated to the third AP device.

14. The computing device of claim 12, wherein the frame further comprises an indication of an amount of time remaining before an indication of an expiration of the portion of the first traffic.

15. The computing device of claim 14, wherein the amount of time is indicated: (i) per radio, (ii) per basic service set (BSS) for a plurality of BSSs in a network or for a subset of the plurality of BSSs, (iii) per access category/traffic identifier (TID) of the portion of the first traffic for a plurality of ACs/TIDs associated with traffic in the network or for a subset of the plurality of ACs/TIDs, or (iv) per BSS per AC/TID for the plurality of ACs/TIDs of each of the plurality of BSSs or for the subset of the plurality of ACs/TIDs of each of the plurality of BSSs.

16. The computing device of claim 12, wherein the frame further comprises an indication, from a fourth AP device, of an amount of time needed to service a portion of fourth traffic in a second service period prior to the first service period.

17. The computing device of claim 11, wherein the schedule of service periods comprises a pseudorandom schedule of service periods.

18. The computing device of claim 11, wherein the first AP device lacks consecutive allocation of service periods within the schedule of service periods.

19. The computing device of claim 11, wherein the predetermined condition comprises a predefined type of traffic or a threshold priority.

20. A non-transitory computer-readable medium comprising computer-executable code, which when executed by one or more processors of a computing device perform an operation comprising:
determining a schedule of service periods allocated to at least one of (i) one or more access point (AP) devices or (ii) one or more aggregated flows associated with the one or more AP devices;
determining, based on the schedule of service periods, a first service period allocated to a first AP device for exchanging first traffic; and
upon determining, in the first service period, that a second AP device has second traffic that satisfies a predetermined condition, allocating a portion of the first service period to the second AP device for communicating the second traffic.
